(19) United States
(12) Patent Application Publication
(10) Pub. No.: US 2017/0219375 A1
(43) Pub. Date: Aug. 3, 2017

(54) WARNING NOTIFICATION SYSTEM, WARNING NOTIFICATION METHOD, AND COMPUTER READABLE MEDIUM

(71) Applicant: Mitsubishi Electric Corporation, Tokyo (JP)

(72) Inventors: Shu MURAYAMA, Tokyo (JP); Junya UJIIE, Tokyo (JP)

(73) Assignee: Mitsubishi Electric Corporation, Tokyo (JP)

(21) Appl. No.: 15/329,182

(22) PCT Filed: Aug. 6, 2014
(86) PCT No.: PCT/JP2014/070726

§ 371 Date: Jan. 25, 2017

(51) Int. Cl. G01C 21/36; G01C 21/34

(52) U.S. Cl. CPC G01C 21/3697; G01C 21/3484; G01C 21/3415; G01C 21/3691

(57) ABSTRACT

The present invention includes a route acquisition unit (210) that acquires moving route information indicating a moving route of a vehicle, a route determination unit (240) that determines whether or not the moving route is a familiar travelling route, a situation acquisition unit (160) that acquires a past travelling situation on the moving route and a present travelling situation on the moving route when the moving route is determined as the familiar travelling route, and a warning determination unit (170) that determines whether or not to issue a warning relating to an event associated with the moving route, based on the past travelling situation on the moving route and the present travelling situation on the moving route.

### TECHNICAL FIELD

The present invention relates to a warning notification system, a warning notification method, and a program. In particular, the present invention relates to a warning notification system, a warning notification method, and a program that appropriately issue a warning to a vehicle.

### BACKGROUND ART

Conventionally, there is a mobile body warning apparatus that determines from a past travelling history whether or not a driver drives on his/her familiar road and issues a warning depending on a determination result. This mobile body warning apparatus issues different notifications depending on the frequency of use of the road (for example, refer to Patent Literature 1).

### CITATION LIST

### Patent Literature

Patent Literature 1: WO 2009/128398 A1

### SUMMARY OF INVENTION

### Technical Problem

In the mobile body warning apparatus of Patent Literature 1, when the road is determined as the familiar road for the driver, there is a case where the warning is not issued even when a travelling situation has changed on the familiar road. Accordingly, even when a risk degree of the familiar road is increased due to the change in the travelling situation, there is a case where the warning is not issued. Therefore, a problem arises that reliability of the warning is low.

The present invention is made to solve a problem such as above and aims to provide a warning notification system, a warning notification method, and a program to issue a warning with high reliability even for a familiar road.

### Solution to Problem

A warning notification system according to the present invention includes:

a route acquisition unit to acquire moving route information indicating a moving route of a vehicle;

a route determination unit to determine whether or not the moving route is a familiar travelling route;

a situation acquisition unit to acquire a past travelling situation on the moving route and a present travelling situation on the moving route when the moving route is determined as the familiar travelling route by the route determination unit; and

a warning determination unit to determine whether or not to issue a warning relating to an event associated with the moving route, based on the past travelling situation on the moving route and the present travelling situation on the moving route.

A warning notification method according to the present invention includes:

by a route acquisition unit, acquiring moving route information indicating a moving route of a vehicle;

by a route determination unit, determining whether or not the moving route is a familiar travelling route;

by a situation acquisition unit, acquiring a past travelling situation on the moving route and a present travelling situation on the moving route when the moving route is determined as the familiar travelling route by the route determination unit; and

by a warning determination unit, determining whether or not to issue a warning relating to an event associated with the moving route, based on the past travelling situation on the moving route and the present travelling situation on the moving route.

A program according to the present invention causes a computer to execute:

route acquisition processing to acquire moving route information indicating a moving route of a vehicle;

route determination processing to determine whether or not the moving route is a familiar travelling route;

situation acquisition processing to acquire a past travelling situation on the moving route and a present travelling situation on the moving route when the moving route is determined as the familiar travelling route by the route determination processing; and

warning determination processing to determine whether or not to issue a warning relating to an event associated with the moving route, based on the past travelling situation on the moving route and the present travelling situation on the moving route.

### Advantageous Effects of Invention

According to the warning notification system of the present invention, a warning determination unit determines whether or not to issue a warning relating to an event, based on a past travelling situation and a present travelling situation on a moving route. Therefore, the warning can be appropriately issued even for a familiar road.

### BRIEF DESCRIPTION OF DRAWINGS

FIG. 1 is a block configuration diagram illustrating an example of a block configuration of a warning notification system according to a first embodiment.

FIG. 2 is a diagram illustrating an example of a configuration of a vehicle information according to the first embodiment.

FIG. 3 is a diagram illustrating an example of a configuration of an environmental situation information according to the first embodiment.

FIG. 4 is a diagram illustrating an example of a configuration of a notification-determination-condition information according to the first embodiment.

FIG. 5 is a diagram illustrating an example of a hardware configuration of a server apparatus and an on-vehicle apparatus according to the first embodiment.

FIG. 6 is a flowchart illustrating an example of an operation of a warning notification method (processing, process) in the warning notification system according to the first embodiment.

FIG. 7 is a flowchart illustrating an example of an algorithm of determination processing according to the first embodiment.

FIG. 8 is a diagram illustrating an example of a block configuration of a warning notification system according to a second embodiment.

FIG. 9 is a flowchart illustrating an example of an operation of a warning notification method in the warning notification system according to the second embodiment.

FIG. 10 is a diagram illustrating an example of a block configuration of a warning notification system according to a third embodiment.

FIG. 11 is a flowchart illustrating an example of an operation of a warning notification method in the warning notification system according to the third embodiment.

### DESCRIPTION OF EMBODIMENTS

### First Embodiment

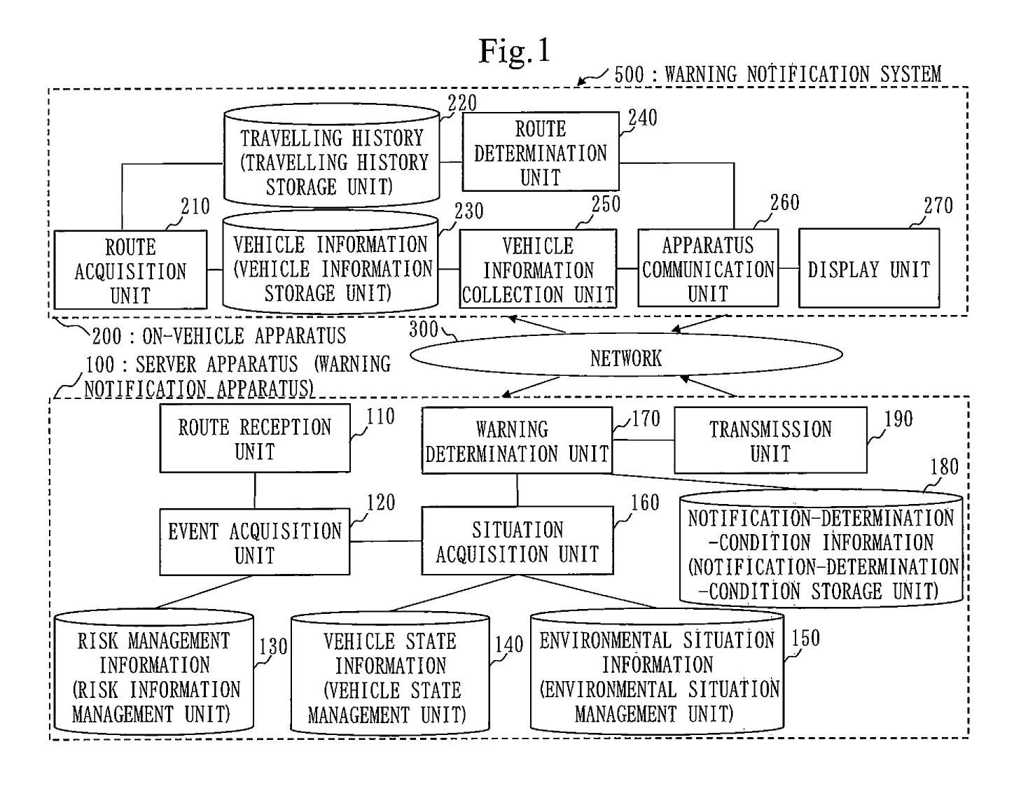

FIG. 1 is a block configuration diagram illustrating an example of a block configuration of a warning notification system 500 according to the present embodiment.

The warning notification system 500 is a driving support system that supports driving by issuing to a driver who drives a vehicle a warning relating to risk information and the like on a moving route on which the vehicle is scheduled to travel.

With reference to FIG. 1, the block configuration of the warning notification system 500 according to the present embodiment will be described.

As illustrated in FIG. 1, the warning notification system 500 includes a server apparatus 100 and an on-vehicle apparatus 200. The server apparatus 100 and the on-vehicle apparatus 200 are connected via a network 300.

The server apparatus 100 is, for example, a server computer located on a data center or the like, or another computer.

The server apparatus 100 is an example of a warning notification apparatus that is connected to the on-vehicle apparatus 200 mounted on the vehicle via the network 300 and issues the warning to the vehicle.

The on-vehicle apparatus 200 is, for example, a navigation apparatus. Alternatively, the on-vehicle apparatus 200 may be a combination of the navigation apparatus or a DA (Display Audio) and a portable terminal (for example, a smart phone, a tablet, and a portable phone). As a part of the on-vehicle apparatus 200, a HUD (Head Up Display) may be also combined.

The on-vehicle apparatus 200 includes a route acquisition unit 210, a route determination unit 240, a vehicle information collection unit 250, an apparatus communication unit 260, and a display unit 270. Further, the on-vehicle apparatus 200 stores a travelling history 220 and a vehicle information 230 in a storage device. The travelling history 220 is stored in the storage device by a travelling history storage unit. The vehicle information 230 is stored in the storage device by a vehicle information storage unit.

The route acquisition unit 210 acquires moving route information indicating the moving route of the vehicle. For example, the driver sets a destination to the on-vehicle apparatus 200 being the navigation apparatus, and thereby the route acquisition unit 210 acquires the moving route.

Based on the travelling history 220, the route determination unit 240 determines whether or not the moving route acquired by the route acquisition unit 210 is a familiar travelling road (route) for a user. The familiar travelling route corresponds to, for example, a route that the user has driven in the past. Further, the familiar travelling route is not limited to the route that the user has driven in the past. For example, when the moving route is in a user's neighborhood area, roads and scenery are familiar to the user. Thus, the moving route should be the familiar travelling route. The user's neighborhood area can be arbitrarily set, and for example, corresponds to an area within several kilometers from a residence of the user. Note that, the user here corresponds to the driver, a passenger, and the like of the vehicle.

The route determination unit 240 determines, for example, whether or not the moving route is the familiar road depending on whether or not the vehicle has travelled on the moving route within a past predetermined period (for example, within a past year or the like). Alternatively, the route determination unit 240 may determine whether or not the movement routs is the familiar road depending on whether the vehicle has travelled on the moving route more than a predetermined number of times within the past predetermined period.

When the route determination unit 240 determines that the moving route is the familiar travelling route, the route determination unit 240 outputs to the apparatus communication unit 260 the moving route information indicating the moving route, a time period in which the vehicle usually travels, and an expected time period in which the vehicle is going to travel on this moving route at this time (at the present). The time period in which the vehicle usually travels corresponds to, for example, a time period in which the vehicle travelled in the past or the like.

The vehicle information collection unit 250 collects information relating to a driving operation on an accelerator, a brake and a handle, and the like; information relating to a motion of the vehicle itself such as a vehicle speed, an acceleration, and a yaw rate; information obtained from a sensor such as a camera, and a radar; and the like. The vehicle information collection unit 250 is realized by a hardware interface that collects the information from the sensor and the like. The vehicle information collection unit 250 may be the sensor itself. The vehicle information collection unit 250 may be implemented, as described below, as a program that executes a function of collecting the information from the sensor and the like.

The vehicle information storage unit stores the information collected by the vehicle information collection unit 250 in the storage device as the vehicle information 230.

The apparatus communication unit 260 transmits, to the server apparatus 100 via the network 300, the moving route information output from the route determination unit 240, the time period in which the vehicle usually travels on this moving route, and the expected time period in which the vehicle is going to travel on this movement rout at this time.

Further, the apparatus communication unit 260 receives warning information from a transmission unit 190 of the server apparatus 100.

The display unit 270 displays the warning on the display device based on the warning information received by the apparatus communication unit 260. The warning is not limited to a display of an image, but may be an audio notification, a vibration notification, or a combination of these.

The network 300 is, for example, a combination of a mobile communication network and the Internet or the like.

The server apparatus 100 includes a reception unit 110, an event acquisition unit 120, a situation acquisition unit 160, a warning determination unit 170, and the transmission unit 190. Further, a risk management information 130, a vehicle state information 140, an environmental situation information 150, and a notification-determination-condition information 180 are stored in a storage device included in the server apparatus 100.

The risk management information 130 is managed by a risk information management unit and stored in the storage device. The vehicle state information 140 is managed by a vehicle state management unit and stored in the storage device. The environmental situation information 150 is managed by an environmental situation management unit and stored in the storage device. The notification-determination-condition information 180 is stored in the storage device by a notification-determination-condition storage unit.

The risk management information 130 is information obtained by associating map information with a risk event (an example of an event) which may occur at a location on a map. The risk management information 130 is a so-called hazard map.

It is assumed that the warning notification system 500 occasionally collects the vehicle information 230 from a member who joins to a warning notification service provided by the warning notification system 500.

For example, in the warning notification system 500, when the driver sets the moving route by using a navigation function of the on-vehicle apparatus 200, the vehicle information 230 may be sent to the server apparatus 100 for each predetermined interval. Further, when the risk event occurs during travelling of the vehicle, the vehicle information 230 including the risk information relating to the risk event may be sent even without following the predetermined interval.

The risk information management unit in the warning notification system 500 receives from the on-vehicle apparatus 200 the vehicle information 230 indicating a state of the vehicle, thereby generating the risk management information 130 based on the received vehicle information 230. As just described, the risk information management unit generates the risk management information 130 based on the risk information collected from the member.

Further, the vehicle state management unit of the server apparatus 100 occasionally stores the vehicle state information 140 indicating the state of the vehicle in the storage device for each vehicle, based on the vehicle information 230 received from the on-vehicle apparatus 200.

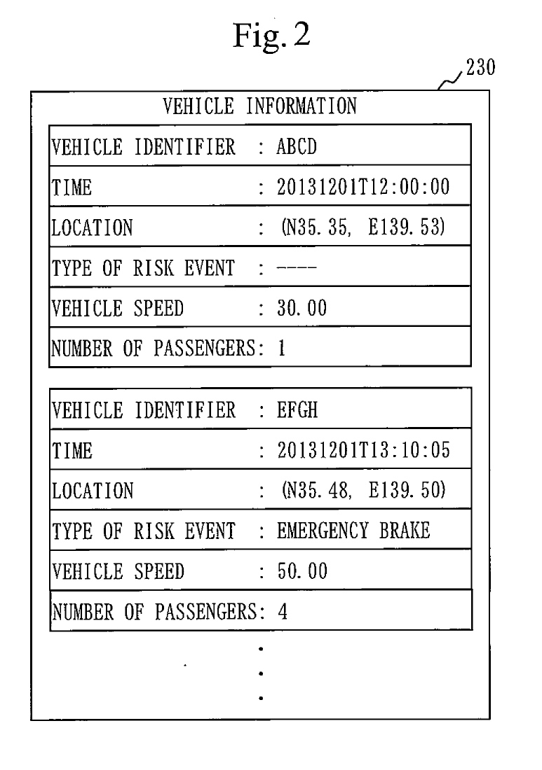

FIG. 2 is a diagram illustrating an example of a configuration of the vehicle information 230 according to the present embodiment.

As illustrated in FIG. 2, in the vehicle information 230, a vehicle identifier that identifies the vehicle, a time, a location (latitude, longitude), a type of the risk event when the risk event occurred, a vehicle speed, a number of passengers, and the like, are set.

The vehicle state management unit stores the received vehicle information 230 in the storage device for each vehicle identifier and treats the received vehicle information 230 as the vehicle state information 140. Alternatively, the vehicle state management unit may accumulate the received vehicle information 230 as it is in the storage device.

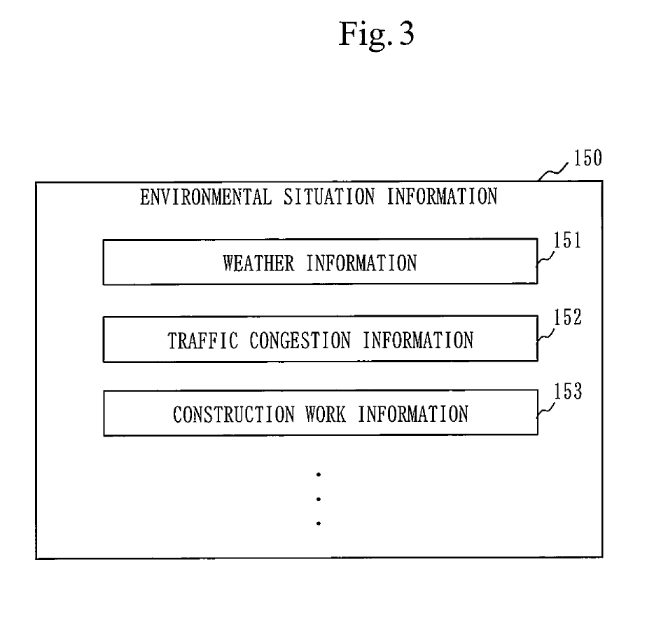

FIG. 3 is a diagram illustrating an example of a configuration of the environmental situation information 150 according to the present embodiment.

As illustrated in FIG. 3, the environmental situation information 150 includes a weather information 151, a traffic congestion information 152, a construction work information 153, and the like. The environmental situation information 150 such as the weather information 151, the traffic congestion information 152 and the construction work information 153 may be acquired based on the vehicle information 230 received from the vehicle.

For example, the environmental situation management unit may detect a traffic congestion location among locations on the map, based on the vehicle information 230 received from the on-vehicle apparatus 200. Alternatively, the environmental situation management unit may be acquired from an external weather database, a traffic congestion information database, a construction work information database, and the like.

Further, when the external weather database, the traffic congestion information database and the construction work information database are only used, the environmental situation information 150 may not be needed.

Referring back to FIG. 1, the description will be continued.

The reception unit 110 receives from the on-vehicle apparatus 200 via the network 300, the moving route information indicating the moving route of the vehicle. The moving route information is location information indicating the moving route.

Based on the risk management information 130, the event acquisition unit 120 acquires the risk information (an example of event information) representing the risk event (an example of an event) associated with the moving route. The risk event associated with the moving route is a risk event associated to have a possibility to occur at a location on the moving route. Alternatively, the risk event associated with the moving route is a risk event associated to be occurring at a location on the moving route.

The risk event corresponds to, for example, events such as a skid, a sharp turn, an emergency brake, a lane reduction, a construction work, attention to a rear-end collision, attention to running out into traffic, and a bump. The risk event may be an event other than these risk events.

The risk information is information including the event information representing the risk event and event location information representing the risk location (an example of an event location) being a location of this risk event. The risk location is, for example, a location where the risk event occurred in the past.

The risk management information 130 is, for example, information in which the risk event such as the attention to running out into traffic is related to the risk location indicating a location where the running out into traffic occurred.

When the route determination unit 240 determines the moving route as the familiar road for the driver of the vehicle (for example, when it is determined that the vehicle travelled on the moving route in the past), the situation acquisition unit 160 acquires a travelling situation at a past time point being a time point in the past at which the vehicle travelled on the moving route and a travelling situation at a present time point being a time point at present. In the description below, there is a case where the travelling situation at the past time point is treated as a usual travelling situation, and the travelling situation at the present time point is treated as an current travelling situation. Note that, the usual travelling situation may be expressed as a past travelling situation, and the current travelling situation may be expressed as a present travelling situation.

Further, the situation acquisition unit 160 acquires the usual travelling situation within a risk range (an example of an event range) on the moving route and the current travelling situation within the risk range. The risk range is a specified range specified in advance including the risk location. For example, the risk range is a range such as a range within 10 meters, a range within 50 meters, or a range within 100 meters from the risk location.

The situation acquisition unit 160 acquires the usual travelling situation and the current travelling situation, based on the vehicle state information 140 and the environmental situation information 150. A method in which the situation acquisition unit 160 acquires the usual travelling situation and the current travelling situation will be described below in detail.

The travelling situation is, for example, a state of the vehicle, a travelling time period of the vehicle, a surrounded circumstance of the vehicle, and the like. The state of the vehicle is, for example, a speed of the vehicle at the time of travelling on the moving route, a number of passengers at the time of travelling on the moving route, and the like. The travelling time period of the vehicle is, for example, a time period at the time of travelling on the moving route, and the like. The surrounded circumstance of the vehicle is weather at the time of travelling, a state of the moving route, and the like. The state of the moving route is a state in which a skyscraper is built along the moving route, a state in which the moving route is under construction, and the like. For example, if the map is updated, the state of the moving route is updated so that the travelling situation changes.

The above described exemplification of the travelling situation is an example. Another situation may be employed if it represents a situation in which the vehicle travels on the moving route.

The notification-determination-condition information 180 stores by associating with each other, the risk event and a notification-determination-condition 181 for determining whether or not to issue the warning relating to this risk event. Here, the notification-determination-condition 181 is a condition for determining whether or not to issue the warning, based on determination information relating to a difference between the travelling situation at the past time point and the travelling situation at the present time point. The determination information is, in other words, information of a result obtained by determining whether or not there is a change between the travelling situation at the past time point and the travelling situation at the present time point. For example, when the usual travelling situation is “the number of passengers is usually 1 person” and the present travelling situation is “the number of passengers is currently 6 people”, information such as “the number of passengers is more than usual” corresponds to the determination information.

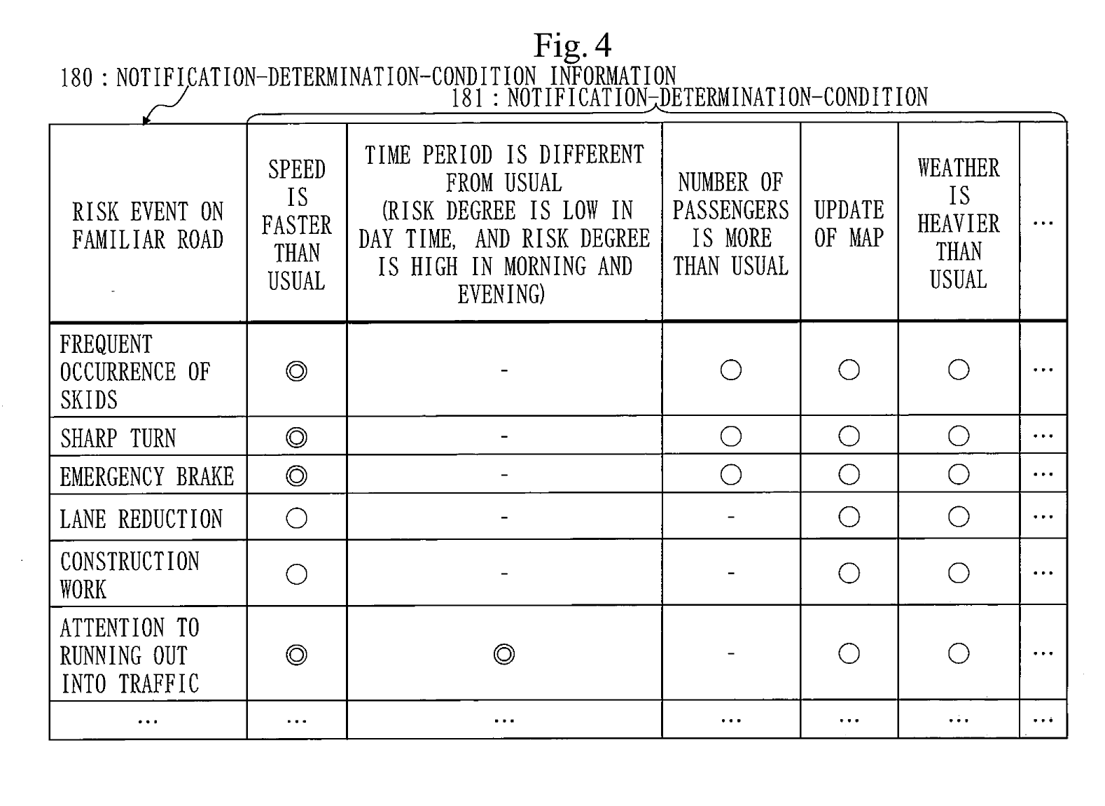

FIG. 4 is a diagram illustrating an example of a configuration of the notification-determination-condition information 180 according to the present embodiment.

As illustrated in FIG. 4, in the notification-determination-condition information 180, the risk event on the familiar road and notification-determination-condition 181 for determining whether or not to issue the warning relating to this risk event, are set.

As illustrated in FIG. 4, in the notification-determination-condition information 180, a plurality of notification-determination-conditions 181 is set to determine whether or not to issue the warning when the speed is faster than usual (the past time point), whether or not to issue the warning when the time period is different from usual, whether or not to issue the warning when the number of passengers is more than usual, whether or not to issue the warning when the map is updated from usual, and whether or not to issue the warning when the weather is heavier than usual, with respect to the risk event on the familiar road.

As long as the notification-determination-condition 181 is a condition for determining whether or not to issue the warning, based on the determination information relating to the difference between usual and present travelling situations, the notification-determination-condition 181 may be another condition in addition to conditions described in FIG. 4.

In FIG. 4, a “hyphen”, a “circle”, and a “double circle” represent the presence or absence of the warning. The “hyphen” represents not to issue the warning. The “circle” represents to issue a normal notification. The “double circle” represents to issue an emphasized notification. The normal notification is to issue the warning by using a normal method. The emphasized notification is to issue the warning by further emphasizing the warning.

For example, if the normal notification is issued by displaying the warning in a normal displaying manner on a display device, the emphasized notification is issued by further emphasizing the warning compared with the normal notification, for example, by flashing the warning or displaying the warning with an alarm.

Further, each priority of the “double circle”, the “circle”, and the “hyphen” set in the notification-determination-condition information 180 is set as follows: priority of the “double circle” >priority of the “circle” >priority of the “hyphen”. For example, when a determination result to issue the emphasized notification and a determination result not to issue the warning are simultaneously obtained, the emphasized notification with higher priority is employed.

The warning determination unit 170 determines by a processing device whether or not to issue the warning relating to the risk event, based on the usual travelling situation and the current travelling situation. The warning determination unit 170 determines by the processing device whether or not the usual travelling situation and the current travelling situation are different and acquires the determination information including the usual travelling situation and the current travelling situation when determining these are different. The warning determination unit 170 determines whether or not to issue the warning using the acquired determination information and the notification-determination-condition 181.

For example, when the risk location whose risk event is “attention to running out into traffic” exists on the moving route, it is assumed that the situation acquisition unit 160 acquires “usually travelling from 11 o'clock to 12 o'clock” as the usual travelling situation and “presently travelling from 7 o' clock to 8 o' clock” as the present travelling situation.

The warning determination unit 170 acquires the determination information including the usual travelling situation and the present travelling situation, that is, information such as “time period is different from usual”.

Regarding the risk event which is “attention to running out into traffic”, the user usually drives in the day time (from 11 clock to 12 o'clock) so that a risk degree is low, but the user currently drives in the morning (from 7 o'clock to 8 o' clock) so that the risk degree is high. Thus, the warning determination unit 170 determines to emphatically display the warning based on the notification-determination-condition information 180.

On the other hand, when the risk location whose risk event is “sharp turn” exists on the moving route, it is assumed that the situation acquisition unit 160 acquires “usually (at the past time point) travelling from 11 o'clock to 12 o'clock” as the usual travelling situation and “travelling presently from 7 o' clock to 8 o' clock” as the present travelling situation.

Regarding the risk event which is “sharp turn”, it is considered that the risk degree due to the time period is not increased so that the warning determination unit 170 determines not to issue the warning based on the notification-determination-condition information 180.

Note that, further at this time, it is assumed that “the number of passengers is usually 1 person” is acquired as the usual travelling situation, and “the number of passengers is currently 6 people” is acquired as the present travelling situation. In this case, the warning according to the condition of the time period is the “hyphen (not to issue the warning)” but the warning according to the increase in the number of passengers is the “circle (the normal notification)”. Thus the warning determination unit 170 determines to ordinary display the warning. This is because that the weight of the vehicle is increased and the current risk degree relating to the sharp turn is increased more than usual so that it is determined that the warning is required to be issued.

The warning determination unit 170 outputs to the transmission unit 190 the warning information including information indicating the contents of the warning and information indicating the strength of the warning.

The transmission unit 190 transmits the warning information acquired from the warning determination unit 170 to the on-vehicle apparatus 200 via the network 300.

In the present embodiment, the warning determination unit 170 and the transmission unit 190 are configured with different block configurations, a single functional block may realize functions of the warning determination unit 170 and the transmission unit 190. Note that, in this case, the classification to the “double circle”, the “circle”, and the “hyphen” are employed in order to have the priority in the notification-determination-condition 181. This classification is not necessarily made in this manner. A classification to simply the “circle” (issue the warning) and the “hyphen” (not to issue the warning) may be employed.

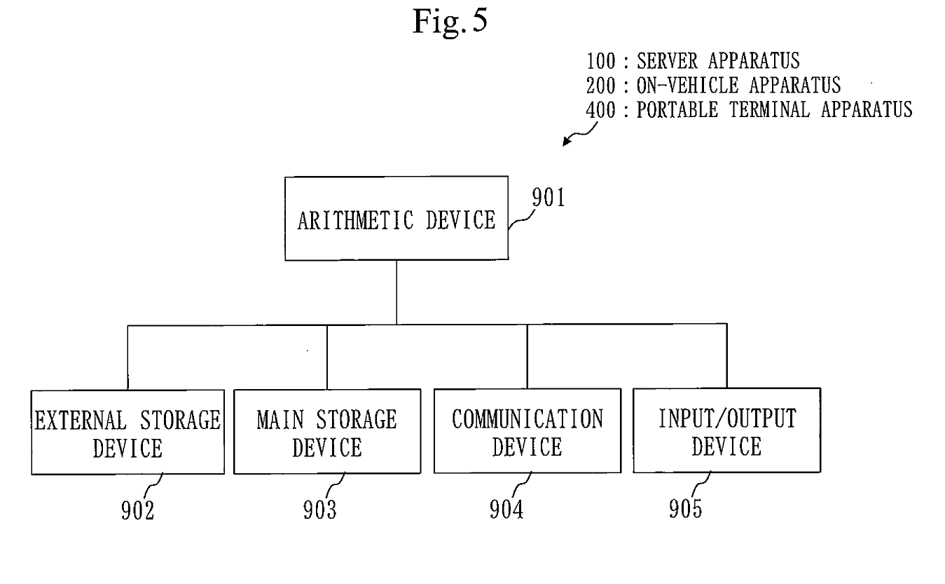

FIG. 5 is a diagram illustrating an example of a hardware configuration of the server apparatus 100 and the on-vehicle apparatus 200 according to the present embodiment.

With reference to FIG. 5, the example of the hardware configuration of the server apparatus 100 and the on-vehicle apparatus 200 will be described.

The server apparatus 100 and the on-vehicle apparatus 200 each is a computer, and each element of the server apparatus 100 and the on-vehicle apparatus 200 can be realized by a program.

As the hardware configuration of the server apparatus 100 and the on-vehicle apparatus 200, an arithmetic device 901, an external storage device 902, a main storage device 903, a communication device 904, and an input/output device 905 are connected to a bus.

The arithmetic device 901 is a CPU (Central Processing Unit) which executes the program. The arithmetic device 901 may be expressed such as, for example, a processing device, a Processor, or a Processing Circuitry.

The external storage device 902 is, for example, a ROM (Read Only Memory), a flash memory, or a hard disk device.

The main storage device 903 is a RAM (Random Access Memory).

The communication device 904 is, for example, a communication board or the like and connected to a LAN (Local Area Network) or the like. The communication device 904 is not necessarily connected to a LAN but may be connected to a WAN (Wide Area Network) such as an IP-VPN (Internet Protocol Virtual Private Network), a wide-area LAN, or an ATM (Asynchronous Transfer Mode) network; or the Internet. The LAN, the WAN, and the Internet are examples of a network.

The input/output device 905 is, for example, a mouse, a keyboard, a display device, or the like. A touch panel, a touch pad, a trackball, a pen tablet, or any other pointing device may be used in place of the mouse. The display device may be an LCD (Liquid Crystal Display), a CRT (Cathode Ray Tube), or any other display device. The display device is an example of the display unit 270 described in the embodiments.

The program is normally stored in the external storage device 902 and loaded into the main storage device 903 to be sequentially read and executed by the arithmetic device 901.

The program is a program that realizes each function described as a “unit” illustrated in the block configuration diagram.

A program product (a computer program product) is configured with a storage medium, a storage device, and the like which records the program that realizes the function of the “unit” illustrated in the block configuration diagram. The program product has a computer readable program loaded therein regardless of its appearance.

Further, an operating system (OS) is also stored in the external storage device 902. At least a part of the OS is loaded into the main storage device 903. The arithmetic device 901 executes, while executing the OS, the program that realizes the function of the “unit” illustrated in the block configuration diagram of FIG. 1.

Application programs are also stored in the external storage device 902. The application programs are loaded into the main storage device 903 and sequentially executed by the arithmetic device 901. For example, the program that realizes functions of the reception unit 110, the event acquisition unit 120, the situation acquisition unit 160, the warning determination unit 170, and the transmission unit 190; the risk management information 130; the vehicle state information 140; the environmental situation information 150; and the notification-determination-condition information 180 are stored in the external storage device 902. The arithmetic device 901 executes the above program using various information stored in the external storage device 902, thereby realizing processing. That is, the function of the “unit” illustrated in the block configuration diagram of FIG. 1 is realized by combining the arithmetic device 901 being hardware and the above program being software. In other words, the arithmetic device 901 is programmed to realize the function of the “unit” illustrated in the block configuration diagram of FIG. 1. Note that, the function is realized not only by the combination of the hardware and the software, but also solely by the hardware through implementing the above program to the arithmetic device 901.

Information such as a “table” is also stored in the external storage device 902. Information, data, signal values, and variable values indicating results of processes described as “evaluate”, “determine”, “extract”, “detect”, “set”, “register”, “select”, “generate”, “input”, “output”, and so on are stored in the main storage device 903.

Data that is received by the server apparatus 100 and the on-vehicle apparatus 200 is also stored in the main storage device 903.

An encryption key, a decryption key, a random number value, and a parameter may also be stored in the main storage device 903.

Note that, the configuration of FIG. 5 is merely the example of the hardware configuration of the server apparatus 100 and the on-vehicle apparatus 200. The hardware configuration of the server apparatus 100 and the on-vehicle apparatus 200 is not limited to the configuration of FIG. 5, but may be another configuration.

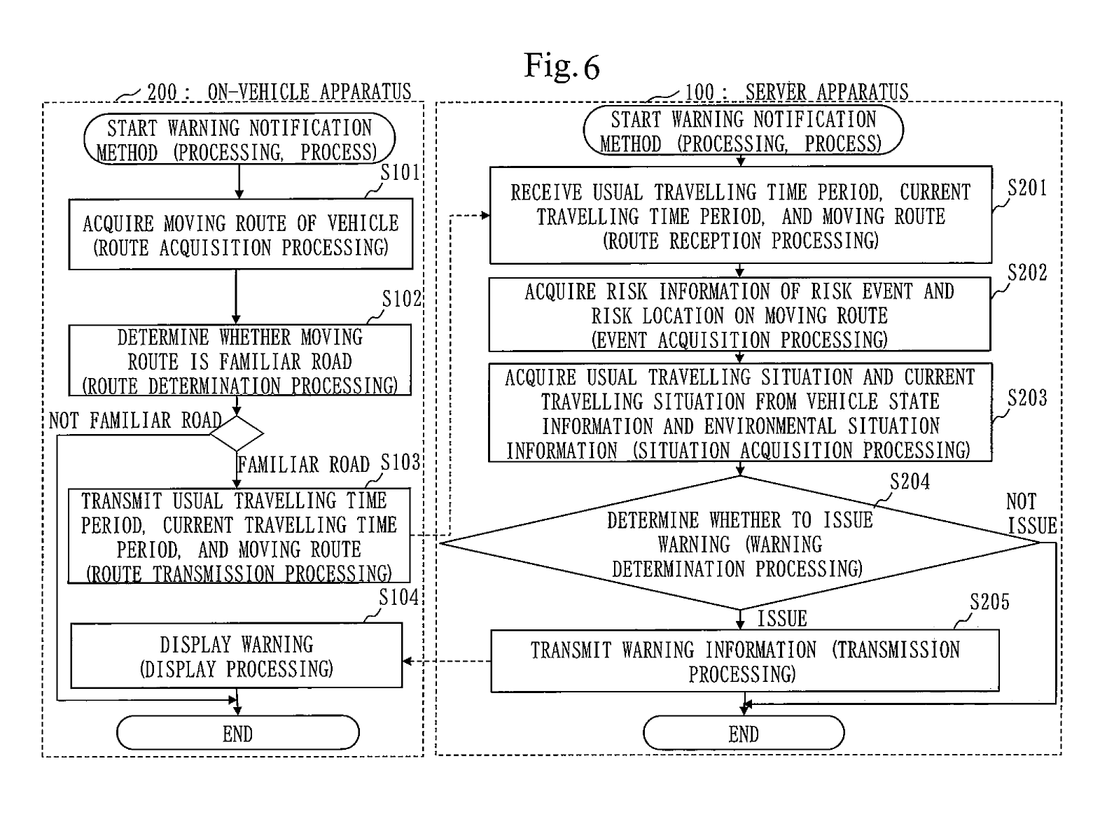

FIG. 6 is a flowchart illustrating an example of an operation of a warning notification method (processing, process) in the warning notification system 500 according to the present embodiment.

With reference to FIG. 6, the operation of the warning notification method (processing, process) in the warning notification system 500 according to the present embodiment will be described.

<Route Acquisition Processing (Process): S101>

In S101, the route acquisition unit 210 of the on-vehicle apparatus 200 acquires a travelling route of the vehicle as the moving route. The route acquisition unit 210 acquires the moving route which is from a present location to a destination of the vehicle, based on the destination set by the user in the on-vehicle apparatus 200 being the navigation apparatus. Alternatively, the route acquisition unit 210 may acquire, as the moving route, a road being within a predetermined range from the present location of the vehicle. Alternatively, the route acquisition unit 210 may acquire the moving route from the tendency of the past travelling route.

<Route Determination Processing (Process): S102>

In S201, based on the travelling history 220, the route determination unit 240 of the on-vehicle apparatus 200 determines by the processing device whether or not the moving route is the familiar road for the driver of the vehicle.

For example, the route determination unit 240 determines using the travelling history 220 whether or not the vehicle has travelled on the moving route in the past. When the vehicle has travelled on the moving route in the past, the moving route is determined as the familiar road. Alternatively, the route determination unit 240 counts using the travelling history 220 the number of times of travelling on the moving route and when the number of times of the travelling is more than a threshold value, the route determination unit 240 determines that the moving route is the familiar road. Alternatively, when the moving route is within a range of a predetermined distance from a residence of the driver, the route determination unit 240 may determine that the moving route is the familiar road.

When the route determination unit 240 determines the moving route is the familiar road, the route determination unit 240 acquires the time period in which the vehicle usually travels on the moving route as a usual travelling time period. The route determination unit 240 acquires the usual travelling time period using the travelling history 220. For example, the route determination unit 240 extracts from the travelling history 220 the time period in which the vehicle usually traveled on the moving route in the past. The route determination unit 240 acquires as the usual travelling time period, a time period indicating a ratio equal to or more than a predetermined ratio from among all of acquired time periods.

When the route determination unit 240 determines that the moving route is the familiar road, the processing proceeds to SI03.

When the route determination unit 240 determines that the moving route is not the familiar road, the processing ends. However, when the route determination unit 240 determines that the moving route is not the familiar road, the route determination unit 240 does not suspend the warning. The route determination unit 240 executes a normal warning notification processing and issues an appropriate warning.

<Route Transmission Processing (Process): S103>

The apparatus communication unit 260 of the on-vehicle apparatus 200 transmits the moving route acquired by the route acquisition unit 210, the usual travelling time period acquired by the route determination unit 240, and an current travelling time period being a time period in which the vehicle travels on the movement rout at this time, to the server apparatus 100 via the network 300.

<Route Reception Processing (Process): S201>

In S201, the reception unit 110 of the server apparatus 100 receives the moving route, the usual travelling time period, and the current travelling time period, from the apparatus communication unit 260 of the on-vehicle apparatus 200 via the network 300.

<Event Acquisition Processing (Process): S202>

In S202, the event acquisition unit 120 acquires the risk information representing the risk event associated with the moving route, based on the moving route received by the reception unit 110 and on the risk management information 130.

For example, it is assumed that the event acquisition unit 120 acquires, as the risk information, a risk location A to be careful of running out into traffic on the moving route.

### <Situation Acquisition Processing (Process): S203>

In S203, the situation acquisition unit 160 acquires the usual travelling situation and the current travelling situation using the vehicle state information 140 and the environmental situation information 150, based on the risk information, the moving route, the usual travelling time period, and the current travelling time period acquired by the event acquisition unit 120.

The situation acquisition unit 160 acquires from the vehicle state information 140 and the environmental situation information 150, the usual travelling situation of the vehicle which travelled on the moving route at the past time point.

Note that, for a certain driver, there is a case where the travelling situation at the past time point is not limited to only one situation. If the vehicle travelled on a certain moving route several times in the past, there were a plurality of travelling situations such as weather is clear in one day or weather is rain in one day. In such cases, the situation acquisition unit 160 acquires the usual travelling situation based on the plurality of travelling situations when the vehicle travelled on the moving route several times in the past.

For example, from the vehicle state information 140 and the environmental situation information 150, the situation acquisition unit 160 may acquire as the usual travelling situation, an average state of the plurality of travelling situations of the vehicle travelled on the moving route in the usual travelling time period. Alternatively, the situation acquisition unit 160 may acquire as the usual travelling situation, a latest travelling situation from among past situations. Alternatively, the situation acquisition unit 160 selects from the plurality of past travelling situations a travelling situation which is closest to the present situation and may acquire the selected travelling situation as the usual travelling situation. Alternatively, the situation acquisition unit 160 may acquire the past travelling situation whose value is identical or the closest to the value in a specified item of the present travelling situation, as the usual travelling situation.

Further, from the vehicle state information 140 and the environmental situation information 150, the situation acquisition unit 160 acquires the current travelling situation of the vehicle which travels on the moving route at the present time point. Alternatively, from the vehicle state information 140 and the environmental situation information 150, the situation acquisition unit 160 may acquire as the current travelling situation, the average state of travelling situations of the vehicle which travelled on the moving route in a predetermined time period including the present time point.

The situation acquisition unit 160 acquires the travelling situation of a specified range (an example of an event range) specified in advance from the risk location A whose risk event is “attention to running out into traffic” acquired by the event acquisition unit 120.

Here, the range specified in advance can be set by a system manager of the warning notification system 500. For example, the range is specified such as within a range of 10 meters, within a range of 50 meters, or within a range of 100 meters.

<Warning Determination Processing (Process): S204>

In S204, the warning determination unit 170 refers to the notification-determination-condition information 180, based on the risk event on the moving route acquired by the event acquisition unit 120, the usual travelling situation and the current travelling situation acquired by the situation acquisition unit 160, and determines by the processing device whether or not to issue the warning.

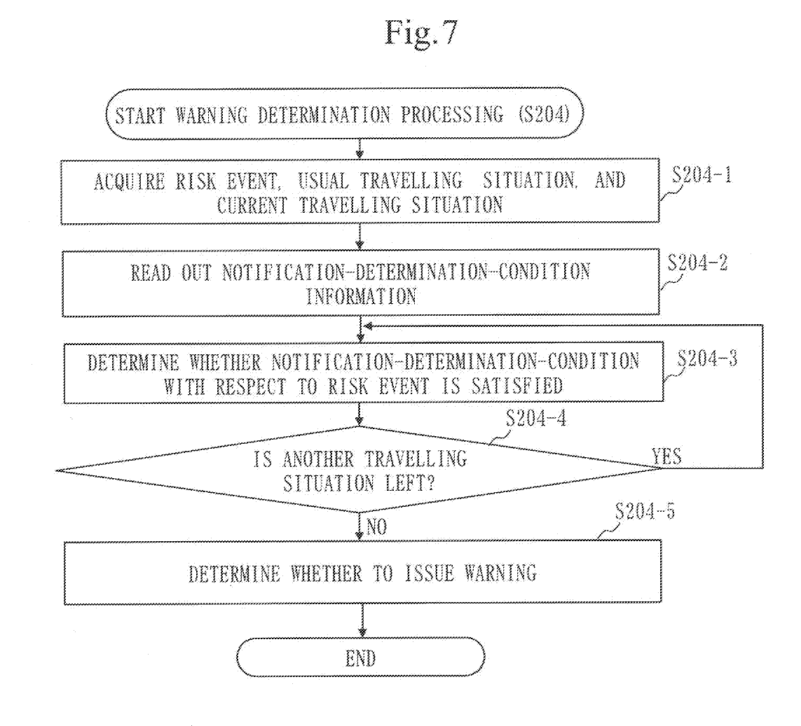

FIG. 7 is a flowchart illustrating an example of an algorithm of the determination processing according to the present embodiment. The arithmetic device 901 is programmed to execute the determination processing by the warning determination unit 170, that is, the algorithm illustrated in FIG. 7 (from the processing of step S204-1 to the processing of step S204-5), thereby realizing the determination processing of step S204.

Firstly, the warning determination unit 170 acquires the risk event from the event acquisition unit 120 and acquires from the situation acquisition unit 160 the usual travelling situation and the current travelling situation (step S204-1). In this example, it is assumed that a notification determination is executed for the risk event being the attention to running out into traffic. Further, “the usual travelling time period is from 12 o'clock to 13 o'clock (in the day time)” is acquired as the usual travelling situation, and “the current travelling time period is from 7 o'clock to 8 o'clock (in the morning)” is acquired as the current travelling situation. Further, “30 kilometers per hour” is acquired as the usual travelling situation, and “50 kilometers per hour” is acquired as the current travelling situation. Further, “the number of passengers is 1 person” is acquired as the usual travelling situation and “the number of passengers is 5 people” is acquired as the current travelling situation.

Next, the warning determination unit 170 reads out the notification-determination-condition information 180 from the storage device (step S204-2). Here, from the notification-determination-conditions 181 with respect to the risk event which is “attention to running out into traffic” illustrated in FIG. 4 in the notification-determination-condition information 180, descriptions relating to “time period is different from usual”, “speed is faster than usual” and “number of passengers is more than usual” are read out.

Next, the warning determination unit 170 refers to the notification-determination-condition information and determines whether the notification determination condition with respect to the risk event is satisfied (step S204-3). Here, the usual travelling situation is “the usual travelling time period is from 12 o'clock to 13 o' clock (in the day time)”, and the current travelling situation is “the current travelling time period is from 7 o'clock to 8 o'clock (in the morning). Thus, the notification-determination-condition 181 which is “time period is different from usual” is satisfied.

The warning determination unit 170 determines whether any other notification-determination-condition 181 is left (step S204-4). When no condition is left, the processing proceeds to step S204-5. When a condition is left, the processing is returned to step S204-3. Here, the rest of the notification-determination-conditions 181 is left, step S204-3 is operated for these. The usual travelling situation is “30 kilometers per hour” and the current travelling situation is “50 kilometers per hour”. Thus, the notification-determination-condition 181 which is “speed is faster than usual” is satisfied. Further, the usual travelling situation is “the number of passengers is 1 person” and the current travelling situation is “the number of passengers is 5 people”. Thus, the notification-determination-condition 181 which is “number of passengers is more than usual” is satisfied.

Next, the warning determination unit 170 determines whether or not to issue the warning (step S204-5). Here, the notification-determination-conditions 181 which are “time period is different from usual”, “speed is faster than usual”, and “number of passengers is more than usual” are all satisfied. As illustrated in FIG. 4, for the notification-determination-condition 181 which is “number of passengers is more than usual” with respect to the risk event which is “attention to running out into traffic”, the notification is not issued since “hyphen” is marked. However, for the notification-determination-conditions 181 which are “time period is different from usual” and “speed is faster than usual”, “double circle” is marked which means an emphasized display. Therefore, the warning determination unit 170 determines to issue the warning relating to the risk event which is “attention to running out into traffic” using the emphasized display to the driver and the like. Note that, the warning is not limited to an image display. It may be a voice notification, a vibration notification or a combination of these.

Note that, here, after the warning determination unit 170 acquires the risk event, the usual travelling situation being the past travelling situation, and the current travelling situation being the present travelling situation, in step S204-1, the warning determination unit 170 reads out the notification-determination-condition information, but this operation is not necessarily limited to this. For example, the warning determination unit 170 firstly determines whether or not the usual travelling situation of the moving route and the current travelling situation of the moving route are different. If different, the processing on and after step S204-2, that is, the determination processing to determine whether or not to issue the warning may be operated. With this procedures, the processing on and after step S204-2 including reading out of the notification-determination-condition information can be eliminated, and processing load can be reduced when there is no difference between the past travelling situation and the present travelling situation.

Referring back to FIG. 6, when the warning determination unit 170 determines not to issue the warning (not issue in S204), the processing ends.

When the warning determination unit 170 determines to issue the warning (issue in S204), the processing proceeds to S205.

<Transmission Processing (Process): S205>

The transmission unit 190 receives from the warning determination unit 170 the warning information for displaying the warning. The warning information includes information indicating the contents of the warning and information indicating the strength of the warning.

For example, the warning determination unit 170 determines to emphatically issue the warning with respect to “attention to running out into traffic” in the vicinity of the risk location A. The warning determination unit 170 outputs to the transmission unit 190 the risk information including the warning with respect to “attention to running out into traffic” and the emphasized notification.

The transmission unit 190 transmits the warning information received from the warning determination unit 170 to the on-vehicle apparatus 200 via the network 300.

<Display Processing (Process): S104>

The apparatus communication unit 260 of the on-vehicle apparatus 200 receives the warning information from the transmission unit 190 of the server apparatus 100.

The display unit 270 displays the waning on the display device based on the warning information received by the apparatus communication unit 260. As a method to issue the warning, in addition to a method of displaying the warning on the display device, for example, the warning may be issued by voice sound. In a case of the normal notification, an announcement such as “Please be careful of a skid” may be output by the voice sound, and in a case of the emphasized notification, a tensed announcement such as “Danger! Danger! Be careful of a rear-end collision!” may be output by the voice sound. Further, the warning may be issued by vibration. In a case of the normal notification, normal vibration may be used, and in a case of the emphasized notification, the warning may be issued by vibration which is stronger than the normal vibration. Further, voice sound, a display to the display device and vibration may be combined to issue the warning.

The warning notification method (processing, process) in the warning notification system 500 according to the present embodiment has been described above.

Note that, in the description of the notification-determination-condition information 180 of FIG. 4, it is assumed that the priority is set in the order of the priority of the “double circle” >the priority of the “circle” >the priority of the “hyphen”.

However, as a method for setting the priority, for example, priority information representing each priority of each of a plurality of notification-determination-conditions 181 may be given to each of the plurality of notification-determination-conditions 181. Then, the warning determination unit 170 may select at least one notification-determination-condition 181 from the plurality of notification-determination-conditions 181, based on the priority given to each of the plurality of notification-determination-conditions 181. The warning determination unit 170 may execute the notification determination processing based on the selected at least one notification-determination-condition 181.

Further, timing for the warning notification system 500 to display the warning on the display device may be set, for example, at a point which is predetermined specified distance before the risk location. For example, the timing is set by the system manager at a point such as 3 kilometers or 2 kilometers before the risk location. Alternatively, when the driver sets the moving route to the on-vehicle apparatus 200, the warning may be issued immediately.

As described above, according to the warning notification system 500 of the present embodiment, a change in the travelling situation can be acquired even for the familiar road. Thus, when the risk degree becomes high due to the change in the travelling situation, the warning can be appropriately issued. For example, there are not many people passing in the day time on a familiar road in front of a school. However, in a case where the driver travels in a school closing time period in the late afternoon, the warning with respect to the attention to running out into traffic is issued, and an appropriate alert can be provided.

Further, according to the warning notification system 500 of the present embodiment, the necessity of the warning is determined on the server apparatus side, and the warning information is transmitted to the on-vehicle apparatus side only when the notification is necessary. Thus, an amount of information can be reduced and a load on the network can be reduced.

Further, according to the warning notification system 500 of the present embodiment, since the notification-determination-condition information 180 is included in the warning notification system 500, it is possible to precisely determine whether or not to issue the warning relating to the risk event depending on the contents of the risk event on the familiar road. Further, since only one type of conditions is determined as one notification-determination-condition 181, it is possible to easily operate the determination processing. Further, it is possible to easily change the notification-determination-condition 181.

As just described, according to the warning notification system 500 of the present embodiment, the change in the travelling situation on the familiar road is appropriately acquired. When the risk degree is not changed compared with that of usual, the warning is not issued and an unnecessary warning is reduced. When the risk degree is higher than usual, an appropriate warning such as the warning with the emphasized display can be realized. Further, the load of the network can be reduced.

### Second Embodiment

In the present embodiment, a difference from the first embodiment will mainly be described.

In the present embodiment, the same reference sign is assigned to the same component unit having the same function as the component units described in the first embodiment and the description of the component unit may be omitted.

In the first embodiment, the on-vehicle apparatus 200 transmits the moving route, the usual travelling time period, and the current travelling time period to the server apparatus 100, and the server apparatus 100 acquires the risk information on the moving route. The warning determination unit 170 determines the necessity of the warning and transmits the warning information to the on-vehicle apparatus 200 when the notification is required.

In the present embodiment, a method will be described in which the server apparatus 100 transmits the risk information acquired by the event acquisition unit 120 and the situation acquisition unit 160, the usual travelling situation, and the current travelling situation to the on-vehicle apparatus 200, and the on-vehicle apparatus 200 determines the necessity of the warning. The on-vehicle apparatus 200 is an example of a warning notification apparatus that determines the necessity of the warning.

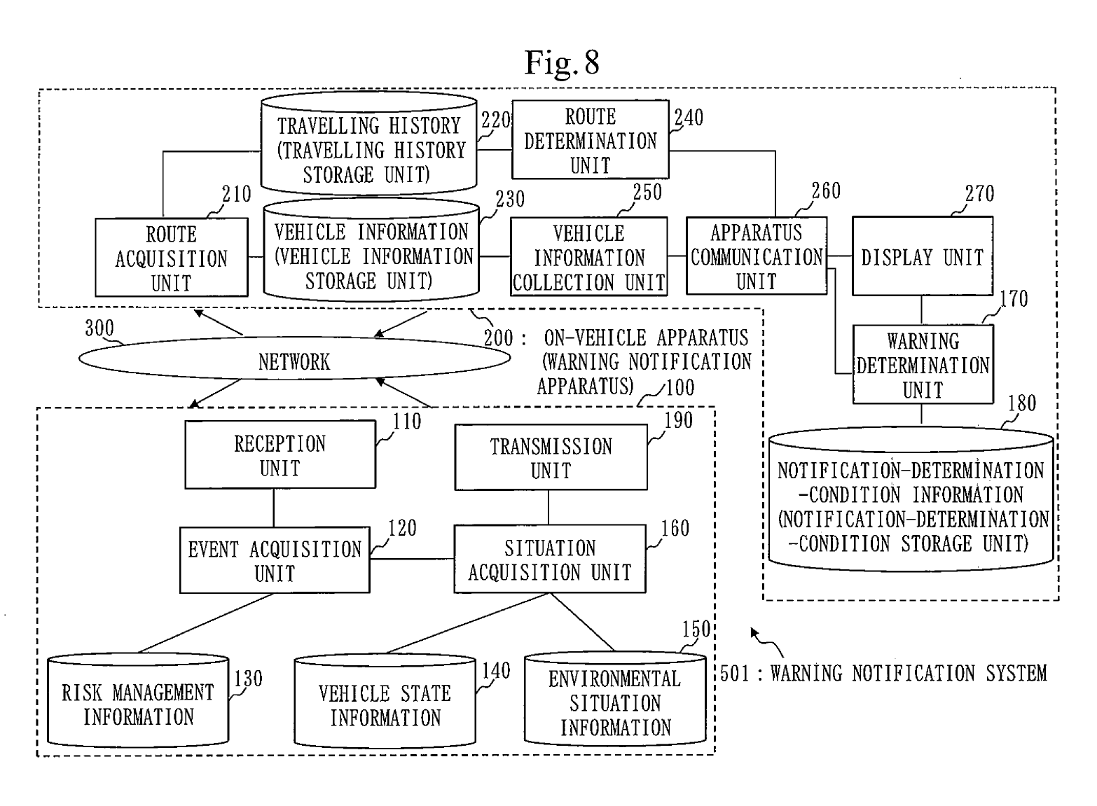

FIG. 8 is a diagram illustrating an example of a block configuration of a warning notification system 501 according to the present embodiment.

As illustrated in FIG. 8, the on-vehicle apparatus 200 includes, in addition to the configuration described in the first embodiment, the warning determination unit 170 and the notification-determination-condition information 180. Also, unlike the configuration described in the first embodiment, the server apparatus 100 does not include the warning determination unit 170 and the notification-determination-condition information 180.

Function configurations of the warning determination unit 170 and the notification-determination-condition information 180 are the same as those described in the first embodiment.

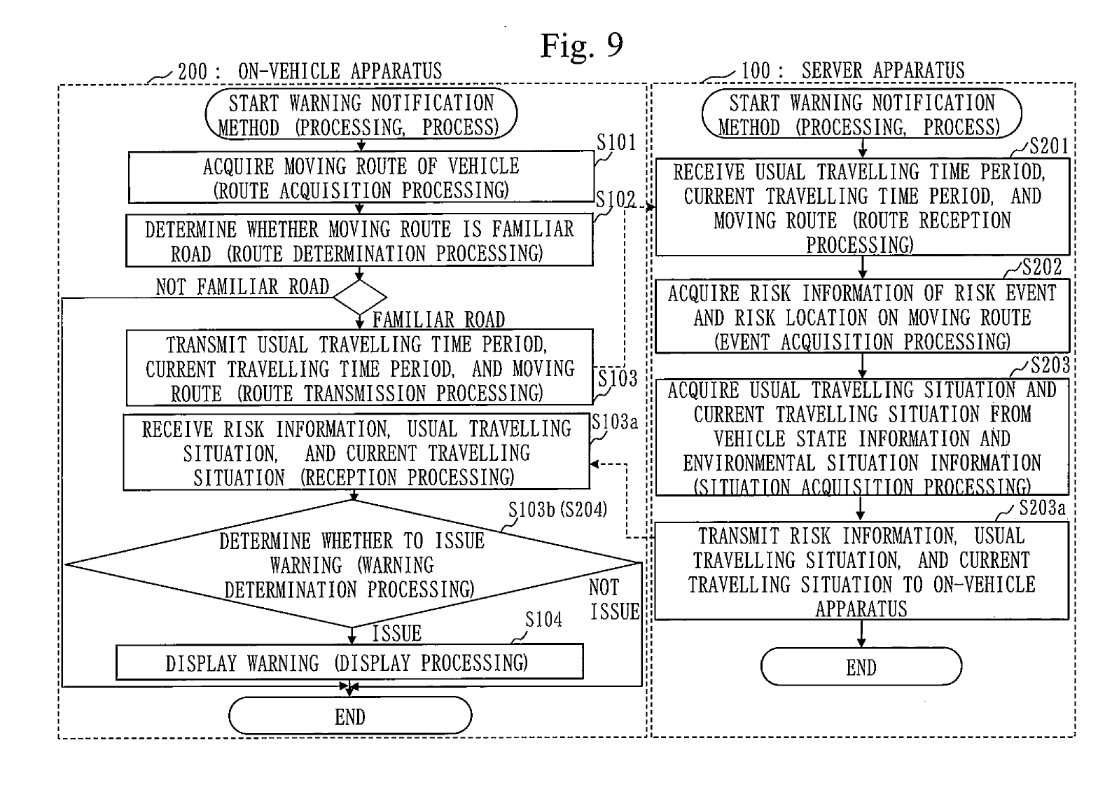

FIG. 9 is a flowchart illustrating an example of an operation of a warning notification method in the warning notification system 501 according to the present embodiment.

With reference to FIG. 9, the example of the operation of the warning notification method in the warning notification system 501 will be described.

In FIG. 9, the processing from S101 to S203 is the same as the processing from S101 to S203 described in FIG. 6 of the first embodiment.

In S203a, the transmission unit 190 transmits the risk information acquired by the event acquisition unit 120 and the usual travelling situation and the current travelling situation acquired by the situation acquisition unit 160 to the on-vehicle apparatus 200.

<Reception Processing (Process): S103a>

In S103a, the apparatus communication unit 260 receives the risk information, the usual travelling situation, and the current travelling situation from the server apparatus 100.

<Warning Determination Processing (Process): S103b>p The processing of S103b is the same as the processing of S204 described in FIG. 6 of the first embodiment. That is, the warning determination unit 170 of the on-vehicle apparatus 200 acquires the risk information, the usual travelling situation, and the current travelling situation via the apparatus communication unit 260. The warning determination unit 170 refers to the notification-determination-condition information 180 based on the usual travelling situation and the current travelling situation and determines the necessity of the warning with respect to the risk event. Then, when the warning determination unit 170 determines to issue the warning, the warning determination unit 170 outputs the risk information including the contents of the warning and the notification method to the display unit 270.

In S104, the display unit 270 displays the warning on the display device in accordance with the warning information. The processing of S104 is the same as the processing of S104 described in FIG. 6 of the first embodiment.

The operation of the warning notification method in the warning notification system 501 according to the present embodiment has been described above.

As described above, according to the warning notification system 501 of the present embodiment, the on-vehicle apparatus 200 includes the notification-determination-condition i nformation 180. Thus, the notification-determination-condition can be changed dynamically on a vehicle side (a driver side). For example, in a case where a driver is not used to deal with an identified risk event even on the familiar road and the warning with respect to this identified risk event is issued, by lighting a condition for issuing the warning, the condition can be set to issue the warning as much as possible. On the other hand, in a case where a driver is an experienced driver or a driver with high driving technique, or the like, a requirement to issue the warning may be strict, and the requirement can be set which enables the warning to be issued only when it is truly necessary.

Note that, a concept of the warning notification system described above is not limited to the system configured with the server apparatus 100 and the on-vehicle apparatus 200, that is, the system configured with a plurality of devices, but may be the server apparatus 100 itself, or the on-vehicle apparatus 200 itself. That is, the warning notification system may be addressed to the server apparatus 100, or the server apparatus 100 including one, some or all of the functions of the on-vehicle apparatus 200. Further, the warning notification system may refer to the on-vehicle apparatus 200, or the on-vehicle apparatus 200 including one, some or all of the functions of the server apparatus 100. The same matter applies to the following description.

### Third Embodiment

In the present embodiment, a difference from the first and second embodiments will mainly be described.

In the present embodiment, the same reference sign is assigned to the same component unit having the same function as the component units described in the first and second embodiments and the description of the component unit may be omitted.

In the present embodiment, a case will be described where a portable terminal apparatus 400 carried by a user is used as a navigation apparatus. The portable terminal apparatus 400 is, for example, a smart phone, a tablet terminal, or the like. In the present embodiment, a method will be described in which the server apparatus 100 transmits the risk information, the usual travelling situation, and the current travelling situation acquired by the event acquisition unit 120 and the situation acquisition unit 160 to the portable terminal apparatus 400, and the portable terminal apparatus 400 determines the necessity of the warning. Further, the portable terminal apparatus 400 includes a function to determine whether the moving route is the familiar road. The portable terminal apparatus 400 is an example of a warning notification apparatus that determines the necessity of the warning.

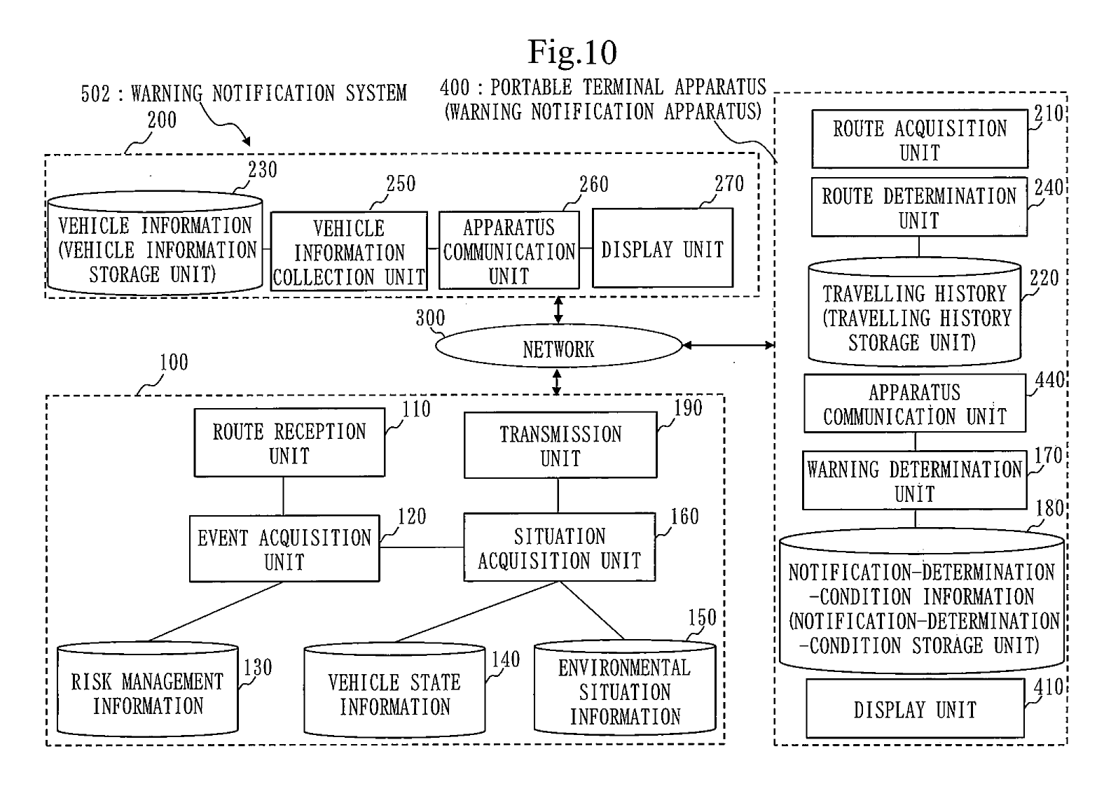

FIG. 10 is a diagram illustrating an example of a block configuration of a warning notification system 502 according to the present embodiment.

As illustrated in FIG. 10, the warning notification system 502 includes the server apparatus 100, the on-vehicle apparatus 200, and the portable terminal apparatus 400. The server apparatus 100, the on-vehicle apparatus 200, and the portable terminal apparatus 400 are connected to each other via the network 300.

The portable terminal apparatus 400 includes the route acquisition unit 210, the route determination unit 240, the travelling history 220, the warning determination unit 170, the notification-determination-condition information 180, a display unit 410, and an apparatus communication unit 440. Difference from the first and second embodiments is that the server apparatus 100 does not include the warning determination unit 170 and the notification-determination-condition information 180 and the on-vehicle apparatus 200 does not include the route acquisition unit 210, the route determination unit 240, and the travelling history 220.

An application for the navigation apparatus is deployed on the portable terminal apparatus 400. The portable terminal apparatus 400 functions as the navigation apparatus.

Function configurations of the route acquisition unit 210, the route determination unit 240, the travelling history 220, the warning determination unit 170, and the notification-determination-condition information 180 are the same as those described in the first embodiment.

The display unit 410 displays map information, destination information, and the like when the portable terminal apparatus 400 functions as the navigation apparatus. Further, the display unit 410 displays the warning on the display device, the warning being determined by the warning determination unit 170 that the notification is necessary.

The apparatus communication unit 440 executes a communication between the portable terminal apparatus 400 and the server apparatus 100, the on-vehicle apparatus 200 connected to the portable terminal apparatus 400 via the network 300.

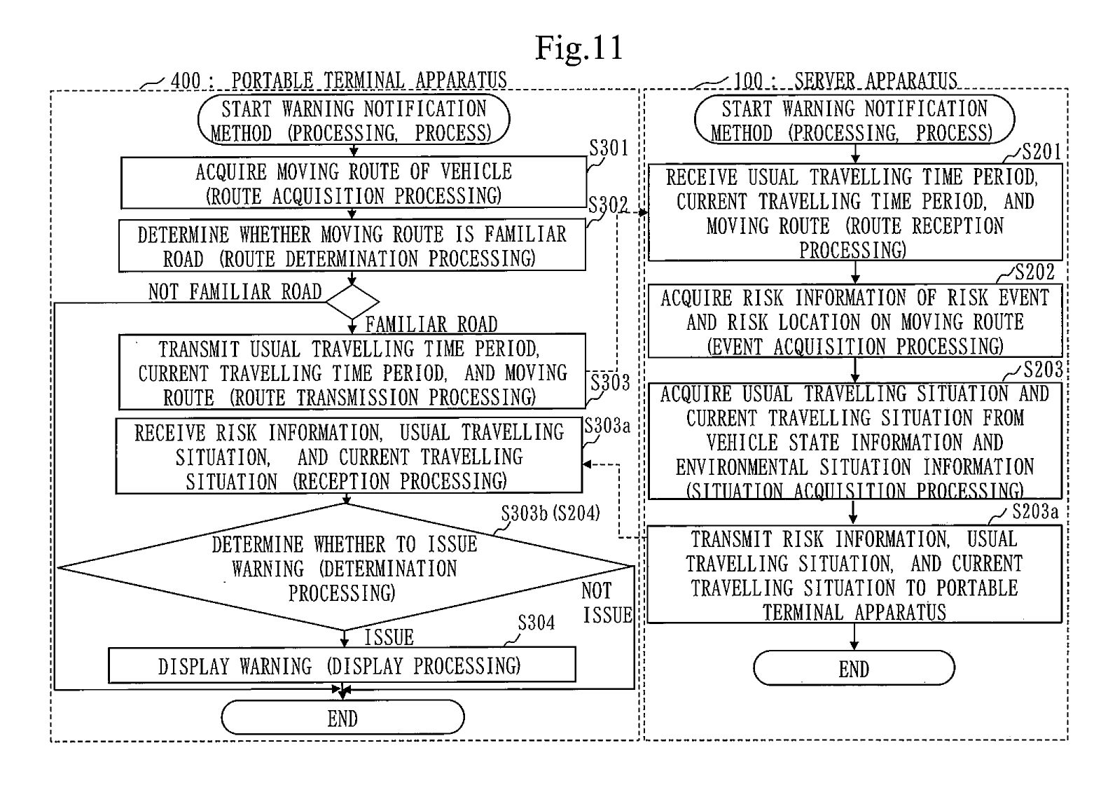

FIG. 11 is a flowchart illustrating an example of an operation of a warning notification method in the warning notification system 502 according to the present embodiment.

With reference to FIG. 11, the example of the operation of the warning notification method in the warning notification system 502 will be described.

In S301, the route acquisition unit 210 of the portable terminal apparatus 400 acquires the travelling route of the vehicle as the moving route. The route acquisition unit 210 acquires the moving route from the present location to the destination of the vehicle, based on a destination set by the user in the portable terminal apparatus 400 being the navigation apparatus. The processing of S301 is the same as the processing of S101 described in FIG. 6 of the first embodiment.

In FIG. 11, the processing from S201 to S203 is the same as the processing from S201 to S203 described in FIG. 6 of the first embodiment.

In S203b, the transmission unit 190 transmits the risk information acquired by the event acquisition unit 120 and the usual travelling time period and the current travelling time period acquired by the situation acquisition unit 160 to the portable terminal apparatus 400 (a smart phone, or a tablet terminal).

In S303a, the apparatus communication unit 440 receives from the server apparatus 100 the risk information, the usual travelling time period, and the current travelling time period. The processing of S303a is the same as S103a described in FIG. 6 of the first embodiment.

The processing of S303b is the same as S204 described in FIG. 6 of the first embodiment. That is, the warning determination unit 170 of the portable terminal apparatus 400 acquires the risk information, the usual travelling time period, and the current travelling time period from the server apparatus 100. The warning determination unit 170 refers to the notification-determination-condition information 180 based on the situation information and determines the necessity of the warning with respect to the risk event. Then, when the warning determination unit 170 determines to issue the warning, the warning determination unit 170 outputs the warning information including the contents of the warning and the notification method to the display unit 410. When the warning determination unit 170 acquires the warning information, the display unit 410 displays the warning on the display device based on the acquired warning information.

When the warning determination unit 170 determines to issue the warning, the warning determination unit 170 may transmit the warning information including the contents of the warning and the notification method to the on-vehicle apparatus 200. The apparatus communication unit 260 of the on-vehicle apparatus 200 receives the warning information, thereby outputting the warning information to the display unit 270 of the on-vehicle apparatus 200. The display unit 270 of the on-vehicle apparatus 200 displays the warning on the display device of the on-vehicle apparatus 200.

Alternatively, when the warning determination unit 170 determines to issue the warning, the warning determination unit 170 outputs the warning information to the display unit 410 and may also transmit the warning information to the on-vehicle apparatus 200.

In S304, the display unit 410 displays the warning on the display device in accordance with the warning information. The processing of S304 is the same as S102 described in FIG. 6 of the first embodiment.

The operation of the warning notification method in the warning notification system 502 according to the present embodiment has been described above.

As described above, according to the warning notification system 502 of the present embodiment, the portable terminal apparatus 400 that functions as the navigation apparatus includes the notification-determination-condition information 180. Thus, the notification-determination-condition can be changed dynamically on a vehicle side (a driver side). Further, even when the vehicle is replaced, a warning notification service by the warning notification system 502 can be easily provided if there is a portable terminal apparatus.

Note that, a concept of the warning notification system described in the present embodiment is not limited to the system configured with the server apparatus 100, the on-vehicle apparatus 200, and the portable terminal apparatus 400, that is, the system configured with a plurality of devices, but may be the portable terminal apparatus 400 itself. That is, the warning notification system may be addressed to the portable terminal apparatus 400 itself. Further, the functional blocks of the warning notification system described in the present embodiments may be arranged distributedly in any manner in the server apparatus 100, the on-vehicle apparatus 200, and the portable terminal apparatus 400.

Note that, the block configuration of the warning notification system is not limited to the block configurations described in the first to third embodiments above. Another configuration of the functional block may be employed and realized.

For example, in the warning notification system, the event acquisition unit and the situation acquisition unit may form a single functional block, and the warning determination unit and the communication unit may form a single functional block.

Various changes can be made to the functional block as needed as far as they are not contradictory, and the block configuration above is an arbitrary. Further, the functional blocks described in the first to third embodiments may be arranged distributedly in any manner in the warning notification system as far as they are not contradictory.

For example, the route determination unit 240 and the travelling history 220 may be included in the server apparatus 100. In this case, there is no need to notify the server apparatus of the usual travelling time period from the vehicle side.

The embodiments of the present invention have been described above. Of the embodiments above, two or more of the embodiments may be combined and performed. Alternatively, of the embodiments above, one of the embodiments may be partially performed. Alternatively, of the embodiments above, two or more of the embodiments may be partially performed.

Note that, the embodiments above are essentially preferable exemplifications and are not intended to limit the present invention, a product to which the present invention has been applied, or the scope of usage of the present invention. Various changes can be made to the embodiments above as needed as far as they are not contradictory.

### REFERENCE SIGNS LIST

100: server apparatus; 110: reception unit; 120: event acquisition unit; 130: risk management information; 140: vehicle state information; 150: environmental situation information; 151: weather information; 152: traffic congestion information; 153: construction work information; 160: situation acquisition unit; 170: warning determination unit; 180: notification-determination-condition information; 181: notification-determination-condition; 190: transmission unit; 200: on-vehicle apparatus; 210: route acquisition unit; 220: travelling history; 230: vehicle information; 240: route determination unit; 250: vehicle information collection unit; 260: .apparatus communication unit; 270: display unit; 300: network ; 400: portable terminal apparatus; 410: display unit; 440: apparatus communication unit; 500, 501, 502, 503: warning notification system; 901: arithmetic device; 902: external storage device; 903: main storage device; 904: communication device; and 905: input/output device.

1.-18. (canceled)

19. A warning notification system comprising:
a route acquisition unit to acquire moving route information indicating a moving route of a vehicle;
a route detemiination unit to determine whether or not the moving route is a familiar travelling route;
a situation acquisition unit to acquire a past travelling situation on the moving route and a present travelling situation on the moving route when the moving route is determined as the familiar travelling route by the route determination unit; and
a warning determination unit to determine whether or not to issue a warning relating to an event associated with the moving route, based on the past, travelling situation on the moving route and the present travelling situation on the moving route, wherein
each of the past travelling situation and the present travelling situation is a state of the vehicle.

20. The warning notification system according to claim 19, wherein the warning determination unit determines whether or not to issue the warning relating to the event when the past travelling situation on the moving route and the present travelling situation on the moving route are different.

21. The warning notification system according to claim 19, comprising
a notification-determination-condition storage unit to store a notification determination condition for determining whether or not to issue the warning when the past travelling situation on the moving route and the present travelling situation on the moving route are different, by corresponding the notification determination condition to the event,
wherein the warning determination unit determines whether or not to issue the warning relating to the event based on the notification determination condition.

22. The warning notification system according to claim 21, wherein a plurality of notification determination conditions is corresponded to the event.

23. The warning notification system according to claim 22, wherein
a priority of the warning is provide to the notification determination condition, and
the warning determination unit selects at least one notification determination condition from the plurality of the notification determination conditions based on the priority, and determines whether or not to issue the warning relating to the event based on the selected notification determination condition.

24. The warning notification system according to claim 19, wherein
the route determination unit determines that the moving route is the familiar travelling route when the vehicle has travelled on the moving route in the past.

25. The warning notification system according to claim 19, wherein
the route determination unit determines that the moving route is the familiar travelling route when the moving route is in a user's neighborhood area.

26. The warning notification system according to claim 19, wherein
the situation acquisition unit acquires the past travelling situation based on a plurality of travelling situations when the vehicle travelled on the moving route several times in the past.

27. The warning notification system according to claim 19, wherein the travelling situation is a surrounded circumstance of the vehicle.

28. The warning notification system according to claim 19, wherein
the situation acquisition unit acquires from the moving route the past travelling situation within an event range including a location of the event and the present travelling situation within the event range.

29. The warning notification system according to claim 19, wherein
the route acquisition unit, the route determination unit, the situation acquisition unit, and the warning determination unit are provided in a server apparatus capable of communicating with an on-vehicle apparatus mounted on the vehicle.

30. The warning notification system according to claim 19, wherein
the route acquisition unit, the route determination unit, the situation acquisition unit, and the warning determination unit are provided in an on-vehicle apparatus of the vehicle.

31. The warning notification system according to claim 19, comprising,
the server apparatus >and an on-vehicle apparatus that is mounted on the vehicle and communicates with the server apparatus,
wherein the route acquisition unit and the route determination unit are provided in the on-vehicle apparatus mounted on the vehicle, and the situation acquisition unit and the warning determination unit are provided in the server apparatus capable of communicating with the on-vehicle apparatus.

32. The warning notification system according to claim 19, wherein
the route acquisition unit, the route determination unit, the situation acquisition unit, and the warning determination unit are provided in a portable terminal apparatus carried by a user.

33. The warning notification system according to claim 19, wherein
the route acquisition unit, the route determination unit, and the warning determination unit are provided in a portable terminal apparatus carried by a user, and the situation acquisition unit is provided in the server apparatus capable of communicating with the portable terminal apparatus.

34. A warning notification method comprising:
by a route acquisition unit, acquiring moving route information indicating a moving route of a vehicle;
by a route determination unit, determining whether or not the moving route is a familiar travelling route;
by a situation acquisition unit, acquiring a past state of the vehicle on the moving route and a present state of the vehicle on the moving route when the moving route is determined as the familiar travelling route by the route determination unit; and
by a warning determination unit, determining whether or not to issue a warning relating to an event associated with the moving route, based on the past state if the vehicle on the moving route and the present state of the vehicle on the moving route.

35. A non-transitory computer readable medium storing a program to cause a computer to execute:
route acquisition processing to acquire moving route information indicating a moving route of a vehicle;
route determination processing to determine whether or not, the moving route is a familiar travelling route;
situation acquisition processing to acquire a past state of the vehicle on the moving route and a present state of the vehicle on the moving route when the moving route is determined as the familiar travelling route by the route determination processing; and
warning determination processing to determine whether or not to issue a warning relating to an event associated with the moving route, based on the past state of the vehicle on the moving route and the present state of the vehicle on the moving route.
